(19) United States
(12) Patent Application Publication
(10) Pub. No.: US 2019/0222827 A1
(43) Pub. Date: Jul. 18, 2019

(54) MULTI-CAMERA SYNCHRONIZATION METHOD, DEVICE, AND STORAGE MEDIUM

(71) Applicant: Shanghai Xiaoyi Technology Co., Ltd., Shanghai (CN)

(72) Inventors: Li JIN, Shanghai (CN); Xuewu ZHANG, Shanghai (CN); Sheng MIAO, Shanghai (CN)

(73) Assignee: Shanghai Xiaoyi Technology Co., Ltd., Shanghai (CN)

(21) Appl. No.: 16/245,501

(22) Filed: Jan. 11, 2019

(30) Foreign Application Priority Data
Jan. 15, 2018 (CN) 201810036668.X

(51) Int. Cl. H04N 13/296; H04N 5/073; H04N 5/232

(52) U.S. Cl. CPC H04N 13/296; H04N 5/232061; H04N 5/073

(57) ABSTRACT

A multi-camera synchronization method, device and system, and storage medium, wherein the method includes searching for a wireless signal from a master camera. Identification information carried in the wireless signal is analyzed, and the identification information is used to establish a wireless connection with the master camera. The wireless connection is used to receive an operation instruction from the master camera. The operation instruction is executed to maintain synchronization with a state with the master camera.

### CROSS REFERENCE TO RELATED APPLICATION

The disclosure claims the benefits of priority to Chinese Application No. 201810036668.X, filed on Jan. 15, 2018, which is incorporated herein by reference in its entirety.

### TECHNICAL FIELD

This disclosure relates to the field of imaging technology, and particularly to a multi-camera synchronization method, device and system, and storage medium.

### BACKGROUND

With the development of photographing and videographing technology, systems such as 360-degree cameras that involve cooperation between a plurality of cameras have appeared. Currently available technology, such as the Yi Halo camera, may connect the plurality of cameras together by wires in order to synchronize their states, simultaneously take photos, and coordinate starting and stopping of video-recording. However, with currently available technology, connecting cameras involves complicated wiring, complex operations, and high manufacturing costs.

### SUMMARY

The technical problem addressed by this disclosure is how to conveniently synchronize a plurality of cameras. In accordance with the present disclosure, there is provided a multi-camera synchronization method including: searching for a wireless signal of a master camera; analyzing identification information carried in the wireless signal found in the search; using the identification information to establish a wireless connection with the master camera; using the wireless connection to receive an operation instruction of the master camera; and executing the operation instruction to maintain synchronization with the state of the master camera.

In accordance with the present disclosure, there is also provided a multi-camera synchronization device including: a search module adapted to search for a wireless signal of a master camera; an analysis module adapted to analyze identification information carried in the wireless signal found in the search; a wireless connection establishment module adapted to use the identification information to establish a wireless connection with the master camera; an operation instruction receiving module adapted to use the wireless connection to receive an operation instruction of the master camera; and a synchronization module adapted to execute the operation instruction to maintain synchronization with a state of the master camera.

In accordance with the present disclosure, there is further provided a multi-camera synchronization system including: a master camera adapted to broadcast a wireless signal; and at least one slave camera including a storage device and a processor, the storage device storing computer instructions executable by the processor to: search for a wireless signal of a master camera, analyze identification information carried in the wireless signal found in the search, use the identification information to establish a wireless connection with the master camera, use the wireless connection to receive an operation instruction of the master camera, and execute said operation instruction to maintain synchronization with a state of the master camera.

In accordance with the present disclosure, there is also provided a non-transitory computer readable storage medium on which computer instructions are stored, the instructions executable by at least one processor to perform a multi-camera synchronization method as disclosed herein.

### BRIEF DESCRIPTION OF THE DRAWINGS

FIG. 1 is a flowchart illustrating a multi-camera synchronization method according to an embodiment of the present disclosure.

FIG. 2 is a partial flowchart illustrating a multi-camera synchronization method according to an embodiment of the present disclosure.

FIG. 3 is a structural diagram illustrating a multi-camera synchronization device. according to an embodiment of the present disclosure.

FIG. 4 is a structural diagram illustrating a multi-camera synchronization system according to an embodiment of the present disclosure.

### DETAILED DESCRIPTION

As stated in the Background, with currently available technology, the ways to connect cameras involve complicated wiring, complex operations, and high manufacturing costs.

Consistent with embodiments of the present disclosure identification information may be obtained through a wireless signal of a master camera to point to the way that a wireless connection is to be established with the master camera. Thus, a wireless connection with the master camera may be established and used to maintain synchronization with the state of the master camera. This averts the complexity of wired connections in currently available technology, provides convenience for operations to maintain synchronization of the states of a plurality of cameras, and also reduces manufacturing costs.

In order to make the aforementioned purpose, characteristics, and advantages of the present disclosure more evident and easier to understand, detailed descriptions are provided below for specific example embodiments of the present disclosure in reference to the drawings attached.

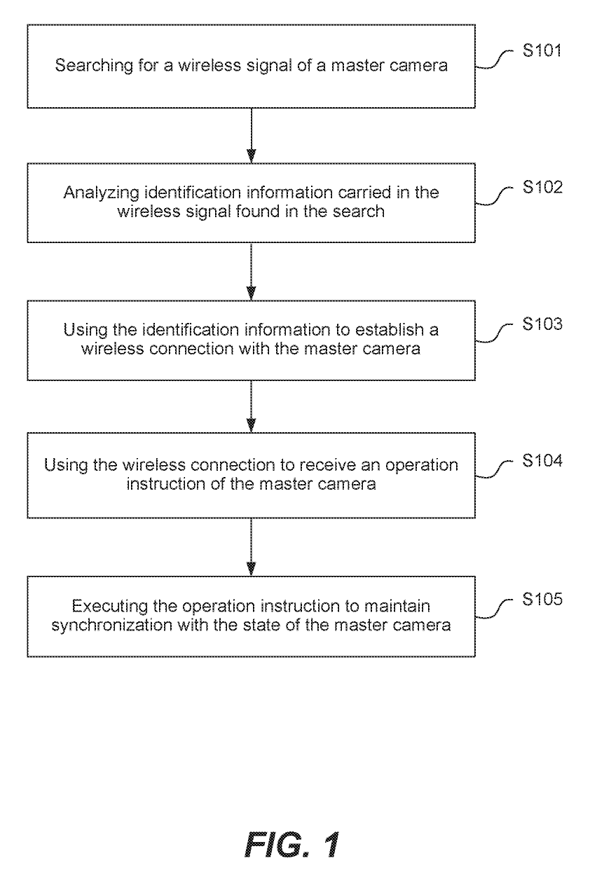

FIG. 1 is a flowchart illustrating a multi-camera synchronization method in one example embodiment of the present disclosure. The multi-camera synchronization method illustrated in FIG. 1 may include the following steps:

Step S101: searching for a wireless signal of a master camera;

Step S102: analyzing identification information carried in the wireless signal found in the search;

Step S103: using the identification information to establish a wireless connection with the master camera;

Step S104: using the wireless connection to receive an operation instruction of the master camera; and

Step S105: executing the operation instruction to maintain synchronization with the state of the master camera.

The multi-camera synchronization method illustrated in FIG. 1 may be performed on another camera, referred to as a slave camera, that is not the master camera. The master camera generates and broadcasts a wireless signal, and another device searches and finds such wireless signal. In one embodiment of Step S101, the slave camera searches for and obtains the wireless signal of the master camera.

In an embodiment of Step S102, the slave camera analyzes the wireless signal of the master camera and obtains the identification information carried in the wireless signal. Here, the identification information points to relevant information for establishing the wireless connection with the master camera. For example, the relevant information may be a name and access password of a hotspot used for establishing a wireless connection with the master camera, or it may be an access password of the wireless signal of the master camera. Optionally, Step S102 includes the step of analyzing an optional field in a beacon frame of the wireless signal to obtain the identification information. In this example embodiment, the wireless signal for broadcast by the master camera includes the beacon frame. Custom information may be written into the optional field in the beacon frame. Therefore, the master camera may write identification information into the optional field of the beacon frame of the wireless signal broadcasted by the master camera. The slave camera may obtain the identification information by analyzing the optional field in the beacon frame of the wireless signal.

Further, after the identification information is written into the optional field of the beacon frame, the identification information may be further encrypted and the encrypted identification information sent out, in order to ensure transmission security of the identification information. Persons having ordinary skill in the art may understand that any implementable encryption algorithm provided by currently available technology may be used for the encryption, such as the Message Digest Algorithm (MD5), or the Data Encryption Standard (DES).

Wireless protocols allow a user to write custom data into an optional field of a beacon frame. Therefore, the example embodiment fully makes use of the optional field so that the identification information may be sent out through the wireless signal of the master camera, thereby achieving wireless connection between a plurality of cameras.

In Step S103, the slave camera uses the identification information to establish the wireless connection with the master camera. The wireless connection may be established using WIFI, Bluetooth, Zigbee or, any other implementable means. Example embodiments of the present disclosure impose no limits in this respect.

In one embodiment of the present disclosure, the identification information is the password for accessing the master camera's WIFI. Step S103 includes a step of using a password to access the master camera's WIFI to establish the wireless connection with the master camera. The wireless connection with the master camera may be established using the wireless signal of the master camera, the wireless signal of the master camera being the master camera's WIFI. Thus, the identification information carried in the wireless signal broadcasted by the master camera is the password for accessing the master camera's WIFI. By analyzing the wireless signal, the slave camera obtains the password for accessing the master camera's WIFI. Then, the slave camera uses the password of the master camera's WIFI to access the master camera's WIFI.

In another embodiment, the master camera accesses a preset hotspot in advance of establishing the wireless connection, and the identification information is a name and access password of the preset hotspot. In this case, Step S103 in FIG. 1 includes the step of using the access password to access the preset hotspot to establish the wireless connection with the master camera. Thus, the wireless connection with the master camera may be established using the preset hotspot. The preset hotspot may be WIFI, Bluetooth, etc. The master camera accesses the preset hotspot in advance, and the identification information carried in the broadcasted wireless signal is the name and access password of the preset hotspot. The slave camera obtains the name and access password of the preset hotspot by analyzing the wireless signal. The slave camera searches for and finds the preset hotspot by the name and uses the access password to access the preset hotspot.

The wireless connection with the master camera is therefore achieved by means of the master camera's WIFI or the preset hotspot. Since the master camera's WIFI and the preset hotspot are easy-to-obtain and easy-to-configure ways of wireless connection, further convenience is achieved in the wireless connection with the master camera.

Additionally, the multi-camera synchronization method may further include the step of using the wireless connection to send the device's own information for the master camera to send the operation instruction. In this embodiment, the slave camera, after establishing the wireless connection with the master camera, may use the wireless connection to send its own device information to the master camera (for example, sending a media access control (MAC) address to the master camera). The master camera sends the operation instruction to the slave camera according to the slave camera's own device information.

After the slave camera has established the wireless connection with the master camera, the master camera may control the slave camera to be in the same state as that of the master camera by way of the wireless connection. In other words, in Steps S104 and S105, the master camera uses the wireless connection to send the operation instruction, and the slave camera uses the wireless connection to receive the operation instruction of the master camera. The slave camera executes the operation instruction which causes the slave camera to maintain synchronization with the state of the master camera. For example, if the current mode of the master camera is a photo mode and, before establishing the wireless connection with the master camera, the slave camera is in a video mode, the slave camera's current mode switches from video mode to photo mode after establishing a wireless connection with the master camera. Additionally, when the shutter of the master camera is activated, the shutter of the slave camera is also activated. This achieves synchronization in the states of the master camera and the slave camera.

Furthermore, identification information may be obtained through the wireless signal of the master camera. This identification information points to the way that the wireless connection is to be established with the master camera, so that the wireless connection with the master camera may be established and then used to maintain synchronization with the state of the master camera. This averts the complexity of wired connections in currently available technology, provides convenience for operations to maintain synchronization of the states of a plurality of cameras, and also reduces manufacturing costs.

Operations instructed by the operation instruction sent by the master camera include taking a photo, taking a video, and changing a parameter. In other words, synchronization may be maintained between the master camera and the slave camera for the operations of taking a photo, taking a video, and changing a parameter. Operations instructed by the operation instruction may further comprise any other implementable camera operations. The given examples impose no limits in this respect.

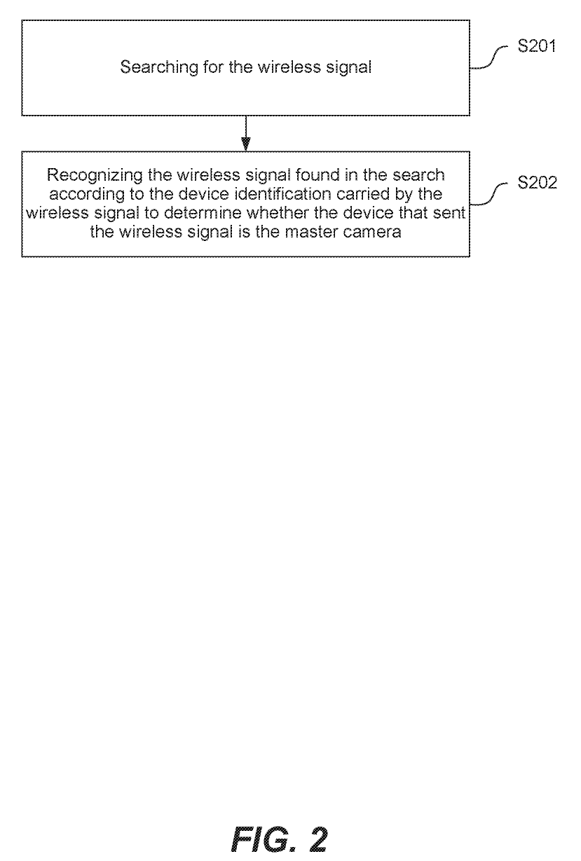

FIG. 2 further illustrates Step S101 of FIG. 1. Step S101 may comprise the following steps:

Step S201: searching for the wireless signal; and

Step S202: recognizing the wireless signal found in the search according to the device identification carried by the wireless signal to determine whether the device that sent the wireless signal is the master camera.

A plurality of wireless signals may be found in the wireless signal search. In this situation, there is a need to recognize a plurality of wireless signals to determine the wireless signal of the master camera.

In this example embodiment, the wireless signals found in the search may be recognized according to the device identification carried by the wireless signals. This device identification may be a MAC address. The MAC address of the master camera is unique; therefore, through the MAC address, it may be determined whether the device of the wireless signal is the master camera. However, the device identification may also be any other information that can provide a unique identification for the device. Example embodiments of the present disclosure impose no limits in this respect.

If it is determined that a plurality of devices of the wireless signals may possibly belong to master cameras, then one of these devices may be randomly selected to be the master camera, or the device with the strongest wireless signal intensity may be selected to be the master camera.

In an embodiment, the master camera may actively broadcast the wireless signal for the slave camera to search for and obtain. In another embodiment, the slave camera may actively broadcast and send a probe request. After the master camera obtains the MAC address of the slave camera via the probe request, the master camera sends a wireless signal.

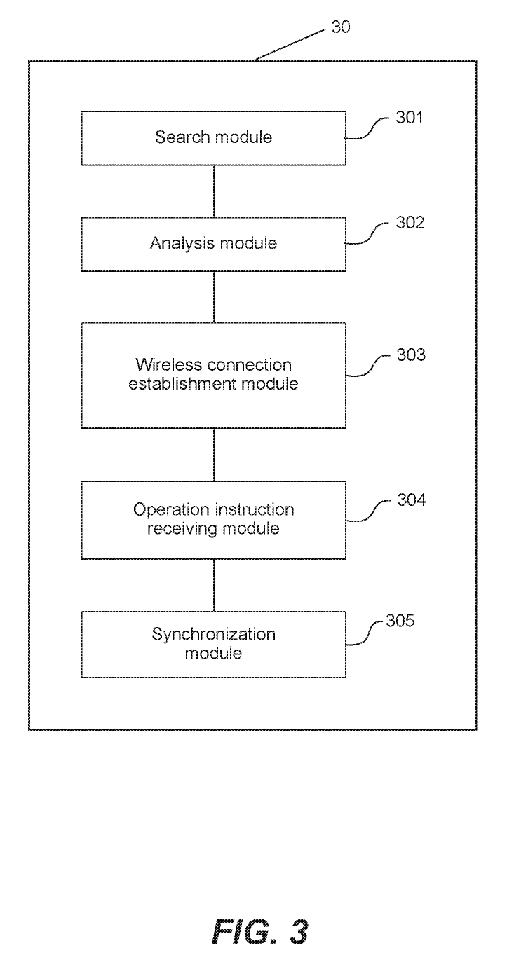

FIG. 3 illustrates a multi-camera synchronization device. The multi-camera synchronization device 30 includes a search module 301, an analysis module 302, a wireless connection establishment module 303, an operation instruction receiving module 304, and a synchronization module 305.

Here, the search module 301 is adapted to search for a wireless signal of the master camera. The analysis module 302 is adapted to analyze identification information carried in the wireless signal found in the search. The wireless connection establishment module 303 is adapted to use the identification information to establish a wireless connection with the master camera. The operation instruction receiving module 304 is adapted to use the wireless connection to receive the operation instruction of the master camera. The synchronization module 305 is adapted to execute the operation instruction to maintain synchronization with the state of the master camera.

The analysis module 302 analyzes an optional field in a beacon frame of the wireless signal to obtain the identification information. Additionally, the search module 301 may further comprise a recognition unit adapted to recognize the wireless signal found in the search according to the device identification carried by the wireless signal to determine whether the device that sent the wireless signal is the master camera.

The identification information may be a password for accessing the master camera's WIFI. The wireless connection establishment module 303 includes a first access unit adapted to use the password to access the master camera's WIFI to establish the wireless connection with the master camera.

Alternatively, the master camera may access a preset hotspot in advance, and the identification information may be a name and access password of the preset hotspot. Thus, the wireless connection establishment module 303 may also include a second access unit adapted to use the access password to access the preset hotspot to establish the wireless connection with the master camera.

The multi-camera synchronization device 30 illustrated in FIG. 3 may further include a device's own-information sending module adapted to use the wireless connection to send the device's own information for the master camera to send the operation instruction.

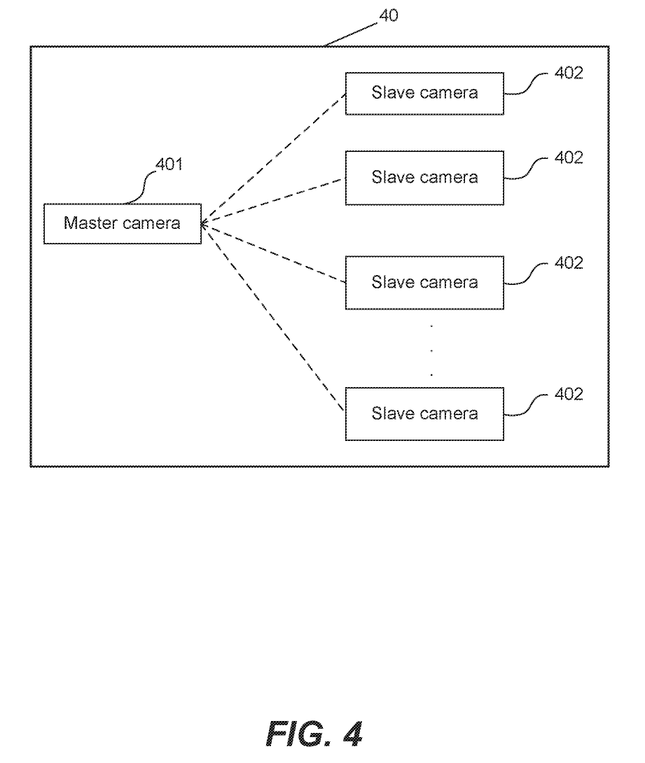

FIG. 4 illustrates an example embodiment of a multi-camera synchronization system. The multi-camera synchronization system 40 includes a master camera 401 and at least one slave camera 402. Here, the master camera 401 is adapted to broadcast wireless signals. The slave camera 402 includes a storage device and a processor. The storage device stores computer instructions that may be run on the processor. The instructions include the steps in the multi-camera synchronization method illustrated in FIG. 1 or FIG. 2, and may be executed by the processor.

In this example embodiment as shown in FIG. 4, there can be a plurality of the slave cameras 402. The master camera 401 may send a control instruction to the slave cameras 402 through the wireless connections, and the slave cameras 402 may maintain synchronization with the state of the master camera 401 by executing the control instruction. Synchronization between a plurality of cameras is achieved by means of the wireless connection between the master camera 401 and the slave cameras 402. This averts wired connections between a plurality of cameras with currently available technology, thus avoiding the complexity in wiring and operation associated with wired connections.

In accordance with another embodiment, a storage medium may store the computer instructions including the steps of the multi-camera synchronization method illustrated in FIG. 1 or FIG. 2. The storage medium may comprise a ROM, a RAM, a magnetic disk, or an optical disc, etc. The storage medium may also comprise a non-volatile storage device or a non-transitory storage device.

In comparison with currently available technology, the present disclosure has a number of benefits. First, by searching for a wireless signal of a master camera, analyzing identification information carried in the wireless signal found in the search, using the identification information to establish a wireless connection with the master camera, using the wireless connection to receive an operation instruction of the master camera, and executing the operation instruction, synchronization can be maintained with the state of the master camera. Additionally, identification information may be obtained through the wireless signal of the master camera, and the identification information may point to the way that a wireless connection is to be established with the master camera. The wireless connection with the master camera may be established and used to maintain synchronization with the state of the master camera. This averts the complexity of wired connections in currently available technology, provides convenience of maintaining synchronization of the states of a plurality of cameras, and also reduces manufacturing costs.

Further, the analyzing identification information carried in the wireless signal found in the search includes analyzing an optional field in a beacon frame of the wireless signal to obtain the identification information. Wireless protocols allow a user to write custom data into an optional field of a beacon frame. Therefore, the technical solution provided by the present disclosure fully makes use of the optional field so that the identification information can be sent out through the wireless signal of the master camera, thereby achieving wireless connection between a plurality of cameras.

Further, the identification information can include a password for accessing the master camera's WIFI, and the password is used to access the master camera's WIFI to establish the wireless connection with the master camera. Alternatively, the access password is used to access the preset hotspot to establish the wireless connection with the master camera. In the technical solution provided by the present disclosure, the wireless connection with the master camera is achieved through the master camera's WIFI or the preset hotspot. Since the master camera's WIFI and the preset hotspot are easy-to-obtain and easy-to-configure ways of wireless connection, further convenience is achieved in the wireless connection with the master camera.

Notwithstanding the above disclosure, the present claims are not limited thereby. Any person having ordinary skill in the art may make various alterations and changes that are not detached from the essence and scope of the disclosed embodiments; therefore, the scope of protection for the present disclosure should be that as defined by the claims.

What is claimed is:

1. A multi-camera synchronization method comprising:
searching for a wireless signal of a master camera;
analyzing identification information carried in the wireless signal found in the search;
using said identification information to establish a wireless connection with the master camera;
using said wireless connection to receive an operation instruction of the master camera; and
executing said operation instruction to maintain synchronization with a state of said master camera.

2. The multi-camera synchronization method of claim 1, wherein said analyzing identification information carried in the wireless signal found in said search comprises:
analyzing an optional field in a beacon frame of the wireless signal to obtain said identification information.

3. The multi-camera synchronization method of claim 1, wherein said searching for a wireless signal of a master camera further comprises:
recognizing the wireless signal found in said search according to a device identification carried by the wireless signal to determine whether the device that sent the wireless signal is the master camera.

4. The multi-camera synchronization method of claim 1, wherein said identification information is a password for accessing a WIFI network of the master camera; and
said using said identification information to establish a wireless connection with said master camera comprises:
using said password to access the WIFI of the master camera to establish the wireless connection with the master camera.

5. The multi-camera synchronization method of claim 1, wherein the master camera accesses a preset hotspot in advance of the searching;
said identification information is a name and access password of said preset hotspot; and
said using said identification information to establish a wireless connection with the master camera comprises:
using said access password to access said preset hotspot to establish said wireless connection with the master camera.

6. The multi-camera synchronization method of claim 1, wherein said method further comprises, after said using said identification information to establish a wireless connection with the master camera:
using said wireless connection to send information of a device for the master camera to send said operation instruction.

7. The multi-camera synchronization method of claim 1, wherein operations instructed by said operation instruction comprise taking a photo, taking a video, or changing a parameter.

8. A multi-camera synchronization device, comprising:
a processor; and
a memory device storing instructions executable by the processor to:
search for a wireless signal of a master camera;
analyze identification information carried in the wireless signal found in the search;
use the identification information to establish a wireless connection with the master camera;
use the wireless connection to receive an operation instruction of the master camera; and
execute the operation instruction to maintain synchronization with a state of the master camera.

9. The multi-camera synchronization device of claim 8, wherein analyzing identification information comprises analyzing an optional field in a beacon frame of the wireless signal to obtain said identification information.

10. The multi-camera synchronization device of claim 8, wherein searching for a wireless signal comprises:
recognizing the wireless signal found in said search according to a device identification carried by the wireless signal to determine whether the device that sent the wireless signal is the master camera.

11. The multi-camera synchronization device of claim 8, wherein
said identification information is a password for accessing a WIFI network of the master camera; and
using the identification information comprises:
using said password to access the WIFI network of the master camera to establish said wireless connection with the master camera.

12. The multi-camera synchronization device of claim 8, wherein
the master camera accesses a preset hotspot in advance of the searching;
said identification information is a name and access password of said preset hotspot; and
using the identification information comprises:
using said access password to access said preset hotspot to establish said wireless connection with the master camera.

13. The multi-camera synchronization device of claim 8, wherein said device further comprises:
using said wireless connection to send the information of the device for the master camera to send said operation instruction.

14. The multi-camera synchronization device of claim 8, wherein operations instructed by said operation instruction comprise taking a photo, taking a video, or changing a parameter.

15. A non-transitory computer readable storage medium on which computer instructions are stored, said instructions executable by at least one processor to:
search for a wireless signal of a master camera;
analyze identification information carried in the wireless signal found in said search;
use said identification information to establish a wireless connection with the master camera;
use said wireless connection to receive an operation instruction of the master camera; and
execute said operation instruction to maintain synchronization with a state of the master camera.
